(19) United States
(12) Patent Application Publication
(10) Pub. No.: US 2012/0069478 A1
(43) Pub. Date: Mar. 22, 2012

(54) INTEGRATED CIRCUIT ESD PROTECTION USING SUBSTRATE IN ESD CURRENT PATH

(75) Inventors: Randy Jacob Caplan, Hoschton, GA (US); Andrew Cole, Sunnyvale, CA (US)

(73) Assignee: FOVEON, INC.

(21) Appl. No.: 12/884,423

(22) Filed: Sep. 17, 2010

(51) Int. Cl. H02H 9/04

(52) U.S. Cl. 361/56

(57) ABSTRACT

A method for conducting ESD current through an integrated circuit formed on a semiconductor substrate includes sensing an ESD potential between a first I/O pad and a second I/O pad of the integrated circuit, providing a current path for ESD current from the first I/O pad of the integrated circuit to a portion of a first metal line in the integrated circuit, providing a current path for ESD current from the portion of the first metal line to the substrate, and providing a current path for ESD current from the substrate to the second I/O pad of the integrated circuit.

### BACKGROUND

1. Field of the Invention

The present invention relates to integrated circuit technology. More particularly, the present invention relates to electrostatic discharge (ESD) structures and methods.

2. Prior Art

During an ESD event, a large voltage difference between two or more pins can result in a large current flowing between these pins through the integrated circuit itself. If a robust path for such current is not explicitly designed, the default path could be through unprotected devices, which could result in the destruction of these devices. To prevent such possible destructive events, an explicit path for the ESD-related current is usually designed using some combination of wide metal power busses, diodes, active clamps, snapback devices, SCR devices, etc.

For large integrated circuits, this approach is often insufficient and/or impractical due in part to the prohibitively wide metal lines that would be required to obtain a sufficiently low-resistance path. For these and for still larger chips, external connections may be needed to supplement any on-chip ESD current path connections. In some cases, these external current path connections can be included as additional routing layers inside the integrated circuit package. In other cases, the packaging scheme may not allow such additional routing layers, and connections outside the packaged integrated circuit may be required. In any case, providing external current path connections, whether in the package or external to the package, increases the manufacturing cost of the final integrated circuit product. Also, integrated circuits requiring such external connections remain poorly protected prior to packaging.

As is typical in the prior art, a minimum of two wide metal power busses (e.g., one for power and one for ground) is required for effective ESD protection. FIG. 1 shows a typical ESD protection scheme of the form known as “Rail Clamp” described in U.S. Pat. No. 5,276,350 to Merrill et al., in which I/O pad 10 is coupled to a positive ESD rail 12 through diode 14 and to negative ESD rail 16 through diode 18. Zener diode 20 is coupled between positive ESD rail 12 and negative ESD rail 16. For large integrated circuits it is difficult to make on-chip power busses 12 and 16 substantial enough to provide an ESD discharge path with a sufficiently low IR drop. Persons of ordinary skill in the art will be familiar with other prior-art variants of the scheme shown in FIG. 1 where the Zener diode is replaced by an active clamp. A number of other prior-art variants exist, such as the use of a snapback device.

In addition, typical prior-art ESD protection schemes employed in integrated circuits having multiple power-supply domains often employ a pair of diodes between the domains, which compounds the problem. Such a scheme is depicted in FIG. 1B, in which positive ESD rail 22 and negative ESD rail 24 are associated with a first power supply domain, positive ESD rail 26 and negative ESD rail 28 are associated with a second power supply domain, positive ESD rail 30 and negative ESD rail 32 are associated with a third power supply domain, and positive ESD rail 34 and negative ESD rail 36 are associated with a fourth power supply domain. Zener diode 38 is coupled between positive ESD rail 22 and negative ESD rail 24, Zener diode 40 is coupled between positive ESD rail 26 and negative ESD rail 28, Zener diode 42 is coupled between positive ESD rail 30 and negative ESD rail 32, and Zener diode 44 is coupled between positive ESD rail 34 and negative ESD rail 36. Opposing diodes 46 and 48 are coupled between negative ESD rails 24 and 28, opposing diodes 50 and 52 are coupled between negative ESD rails 28 and 32, and opposing diodes 54 and 56 are coupled between negative ESD rails 32 and 36. Note that each additional diode pair in the path between two power domains increases the voltage difference required to trigger an ESD current between these two domains; such an increase in this ESD event trigger voltage generally suggests a decrease in ESD protection of the integrated circuit.

### BRIEF DESCRIPTION

According to the present invention, an ESD protection architecture uses the integrated circuit substrate as an ESD current path for larger distances rather than using an explicit power bus. The present invention improves ESD performance while eliminating the need for a large-area-consuming explicit ESD current line or external connections, and also enables the use of multiple ground domains without sacrificing ESD performance. In integrated circuits employing multiple isolated power-supply domains, connections to the substrate may be made either directly or through a pair of opposed diodes. Using the substrate as an ESD current path allows one of the wide metal busses typically used for ESD protection to be removed or significantly reduced in width. This can potentially save a large amount of chip area. This may also result in even better protection than if an explicit metal bus is used, for although the substrate typically has a higher sheet resistance than a metal line, a smaller effective length-to-width ratio for the substrate path will often result in a smaller resistance for the substrate path. In addition, in integrated circuits with many supply domains, use of the substrate as an ESD current path can reduce the number of series-connected diodes in an ESD current path between two separate domains.

### BRIEF DESCRIPTION OF THE DRAWING FIGURES

FIG. 1A is a diagram illustrating a simple prior-art ESD protection scheme using a Zener diode as an ESD protection element.

FIG. 1B is a diagram illustrating a typical prior-art ESD protection scheme employed in integrated circuits having multiple power-supply domains.

FIG. 2 is a diagram illustrating an exemplary ESD protection arrangement according to one aspect of the present invention.

FIG. 3 is a diagram showing by illustrative example how ESD current pulses may flow between two power supply domains according to an aspect of the present invention.

FIG. 4 is a diagram showing how an ESD current pulse may flow through a typical prior-art integrated circuit from a first I/O pad to a second I/O pad.

FIG. 5 is a diagram showing how an ESD current pulse may flow through a typical integrated circuit from a first I/O pad to a second I/O pad in accordance with the principles of the present invention.

### DETAILED DESCRIPTION

Persons of ordinary skill in the art will realize that the following description of the present invention is illustrative only and not in any way limiting. Other embodiments of the invention will readily suggest themselves to such skilled persons. For example, while the following description may refer to a Zener diode being used as an ESD protection element, one skilled in the art will recognize that the present invention may be readily used with other types of ESD protection elements.

According to one aspect of the present invention, an ESD architecture employs the integrated circuit substrate as a portion of an ESD current path rather than using an explicit power bus formed from a metal line. During an ESD event, a large amount of current is forced on to the integrated circuit, and this current must return off of the integrated circuit by some path. For long distances, use of the substrate in this ESD current path results in a lower IR drop along the path.

Before the present invention, a minimum of two wide-metal-line power busses were required for effective ESD protection (e.g., power, ground). The present invention makes use of the fact that the integrated circuit substrate can provide a low resistance path, thus allowing one of the two wide metal busses (e.g., ground) to be removed or significantly reduced in size. This can potentially save a large amount of chip area and may also result in even better ESD protection than if an explicit metal-line bus is used. In addition, employing the techniques of the present invention enables the use of multiple isolated ground/power domains with no more than two pairs of opposing diodes in the ESD path between any two domains regardless of the number of domains. In contrast, prior-art techniques rely on a worst-case N−1 pairs of opposing diodes in the path between two domains of an N-domain circuit. Such a reduction in the number of diodes in the ESD path suggests superior ESD protection using the techniques of the present invention, since additional diodes in the ESD path suggest a higher voltage needed to trigger the ESD protection mechanism.

Referring now to FIG. 2, a diagram shows an ESD protection scheme according to one aspect of the present invention. FIG. 2 shows an illustrative example in which the integrated circuit includes three separate power supply domains 60, 62, and 64 that are electrically isolated from one another. Persons skilled in the art will appreciate that isolation of separate power supply domains may be used to separate logic and analog power supplies, or a logic power supply having a first voltage potential from a logic power supply having a second voltage potential. Also note that while only one I/O pad is shown for each power supply domain, an integrated circuit will generally include multiple I/O pads for each domain.

Power supply domain 60 includes a positive supply (V_{DD}) rail 66 and negative supply (V_{SS}) rail 68. An ESD protection element in the form of a Zener diode 70 is coupled between V_{DD} rail 66 and V_{SS} rail 68. V_{SS} rail 68 is coupled to substrate 72 through opposing diodes 74 and 76. While a Zener diode is shown in the illustrative embodiment of FIG. 2 to disclose the principles of the invention, persons skilled in the art will readily appreciate that other types of ESD protection elements could also be employed. Non-exhaustive examples of other ESD protection elements include voltage breakdown structures such as snapback MOS devices, silicon controlled rectifiers (SCRs), avalanche diodes, and other structures such as circuits designed to switch on as a voltage or rate of change of a voltage passes through a specific range.

Power supply domain 62 includes V_{DD} rail 78 and V_{SS} rail 80. Zener diode 82 is coupled between V_{DD} rail 78 and V_{SS} rail 80. V_{SS} rail 80 is coupled to substrate 72 by direct connection 84. Persons skilled in the art will appreciate that V_{DD} rail 78 in power supply domain 64 is electrically isolated from V_{DD} rail 66 in power supply domain 60. Similarly, V_{SS} rail 80 in power supply domain 62 is electrically isolated from V_{SS} rail 68 in power supply domain 60.

Power supply domain 64 includes V_{DD} rail 86 and V_{SS} rail 88. Zener diode 90 is coupled between V_{DD} rail 86 and V_{SS} rail 88. V_{SS} rail 88 is coupled to substrate 72 through opposing diodes 92 and 94. Persons skilled in the art will appreciate that V_{DD} rail 86 in power supply domain 64 is electrically isolated from V_{DD} rails 66 and 78 in power supply domains 60 and 62. Similarly, V_{SS} rail 88 in power supply domain 64 is electrically isolated from V_{SS} rails 68 and 80 in power supply domains 60 and 62.

The structures shown in FIG. 2 allow ESD current in either direction through the substrate 72. ESD current entering via I/O pad 96 in power supply domain 60 will be passed through diode 98 to V_{DD} rail 66 and then shunted to V_{SS} rail 68 through Zener diode 70. The ESD current is then directed to substrate 72 through diode 74. ESD current entering from another I/O pad may also flow from substrate 72 to V_{SS} rail 68 in power supply domain 60 through diode 76 and through diode 100 to exit via to I/O pad 96.

Similarly, ESD current entering via I/O pad 102 in power supply domain 62 will be passed through diode 104 to V_{DD} rail 78, shunted to V_{SS} rail 80 through Zener diode 82, and then directed to substrate 72 through direct connection 84. ESD current entering from another I/O pad may also flow from substrate 72 to V_{SS} rail 80 in power supply domain 62 through direct connection 84 and through diode 106 to exit via I/O pad 102. In like fashion, ESD current entering via I/O pad 108 in power supply domain 64 will be passed through diode 110 to V_{DD} rail 86, shunted to V_{SS} rail 88 through Zener diode 90, and then directed to substrate 72 through diode 94. ESD current entering from another I/O pad may also flow from substrate 72 to V_{SS} rail 88 in power supply domain 64 through diode 92 and through diode 112 to exit via I/O pad 108.

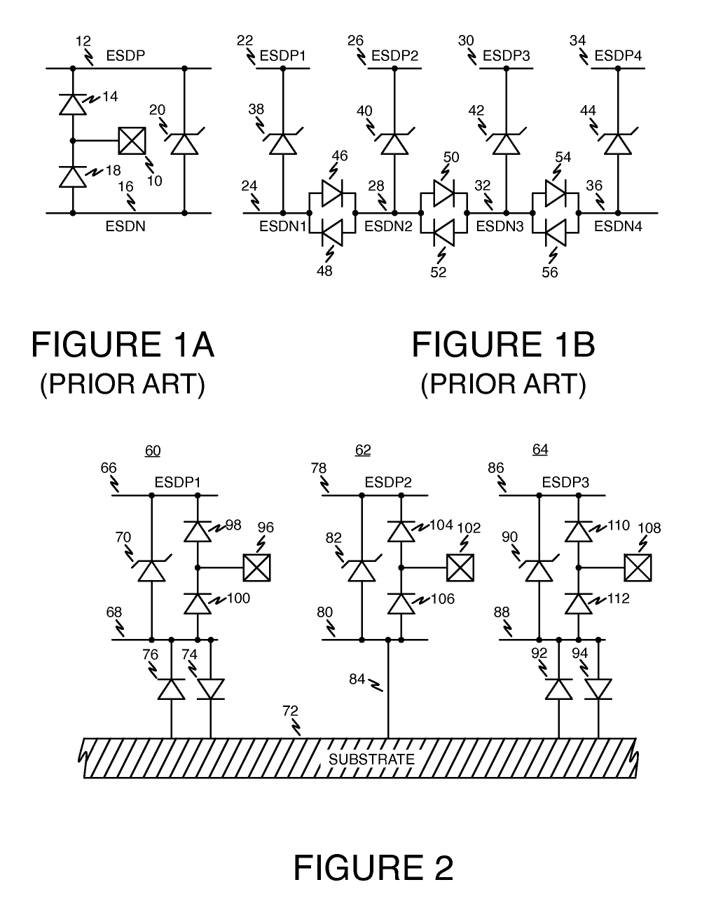

One of the advantages of the circuit of FIG. 2 over the prior-art ESD protection circuit shown in FIG. 1B is that the worst-case number of diode drops encountered in the ESD current path is two. For example, in FIG. 2 according to one aspect of the present invention, the current path for an ESD potential imposed on the integrated circuit between I/O pad 96 and I/O pad 108 includes only a pair of diodes (diodes 74 and 92 or diodes 76 and 94, depending on the polarity of the ESD potential). In other cases, where one of the power supply domains involved in the ESD event is connected to the substrate 72 through direct connection 84, only a single pair of diodes exists in the ESD protection current path. In contrast, the current path for an ESD potential imposed on the integrated circuit between the first and fourth power supply domains in the ESD protection scheme depicted in FIG. 1B includes at least three diodes (diodes 46, 50, and 54 or diodes 48, 52, and 56, depending on the polarity of the ESD potential).

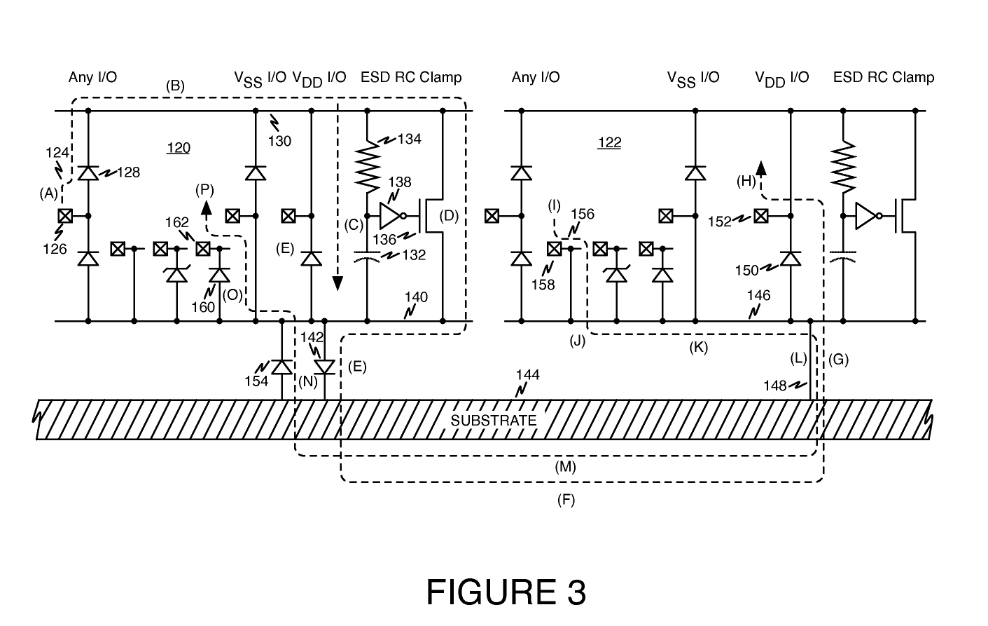

Referring now to FIG. 3, a diagram shows by illustrative example how an ESD pulse may be handled across two electrically-isolated power supply domains (shown at reference numerals 120 and 122) by using the substrate as a discharge current path and electrically coupling multiple power-supply domains to the substrate in accordance with an aspect of the present invention. While an example using two power supply domains is shown in FIG. 3, persons skilled in the art will readily appreciate that the principles of the present invention apply to arbitrary numbers of such domains. The circuitry shown in FIG. 3 is similar to that shown in FIG. 2, except that clamp transistors are shown employed as ESD protection elements in the place of the Zener diodes shown in FIG. 2 and that only two power supply domains are shown instead of the three shown in FIG. 2.

In a first particular example shown in FIG. 3, a dashed line 124 indicates one possible path of an ESD current through the circuit. First, as indicated at (A), a positive ESD (current) pulse flows into I/O pad 126 in a first supply domain 120 and passes through positive clamp diode 128 to the V_{DD} rail 130 at (B). The voltage at the V_{DD} rail 130 increases rapidly, while the voltage across capacitor 132 increases less rapidly due to the low-pass RC filter formed by resistor 134 and capacitor 132 as indicated at (C). The RC circuit is coupled to the gate of n-channel MOS clamp transistor 136 through inverter 138. The more rapid increase of the voltage at V_{DD} rail 130 relative to the voltage across capacitor 132 causes inverter 138 to sense a low input level and to output a high level, which causes clamp transistor 136 to turn on. The ESD current flows through this clamp transistor 136 to the V_{SS} rail 140 as indicated at (D). The clamp transistor thus limits the peak voltage difference between V_{DD} rail 130 and V_{SS} rail 140 during an ESD event, protecting the transistors in the core of the integrated circuit. Thus, resistor 134, capacitor 132, transistor 136 and inverter 138 form an active rail clamp. Persons of ordinary skill in the art will appreciate that, in a given integrated circuit, a single RC circuit may be used to drive the gates of multiple clamp transistors like transistor 136 within a single power supply domain. Such skilled persons will also recognize that other rail clamp circuits or devices, such as circuits designed to switch on as a voltage or rate of change of a voltage passes through a specific range, may be used in accordance with the present invention.

As indicated at (E), after the clamp transistor 136, the ESD current flows along the V_{SS} rail 140 and is shunted to the substrate through diode 142. As indicated at (F), the ESD current flows through the substrate 144 to the second supply voltage domain 122. Once in the second supply domain 122, and as indicated at (G), the ESD current flows into local V_{SS} rail 146 via direct connection 148. The ESD current then flows through diode 150, and out of the integrated circuit at the I/O pad 152 as indicated at (H).

As will be appreciated by persons of ordinary skill in the art, the ESD current in the example of FIG. 3 has been controlled, and the integrated circuit will not be damaged if the impedance of the ESD current path is low enough. Persons skilled in the art will observe that different voltage domains may be connected to the substrate 144 using back-to-back diodes like diode 142 and its reverse companion 154, or by direct connections such as 148, depending on the particular isolation needs of the integrated circuit.

Available ESD paths through the substrate do not always involve two voltage rails. In a second particular example shown in FIG. 3, a dashed line 156 indicates another possible path of an ESD current through the circuit. First, as indicated at (I), a positive ESD current pulse flows into I/O pad 158 in the second supply domain 122 and passes directly to the V_{SS} rail 146 at (J). As indicated at (K), the ESD current flows along the V_{SS} rail 146 and is shunted to the substrate via direct connection 148 as indicated at (L). As indicated at (M), the ESD current flows through the substrate 144 to the first supply domain 120. As indicated at (N) the ESD current flows into local V_{SS} rail 140 through diode 154, and as indicated at (O), the ESD current flows through diode 160, and out of exit I/O pad 162 as indicated at (P).

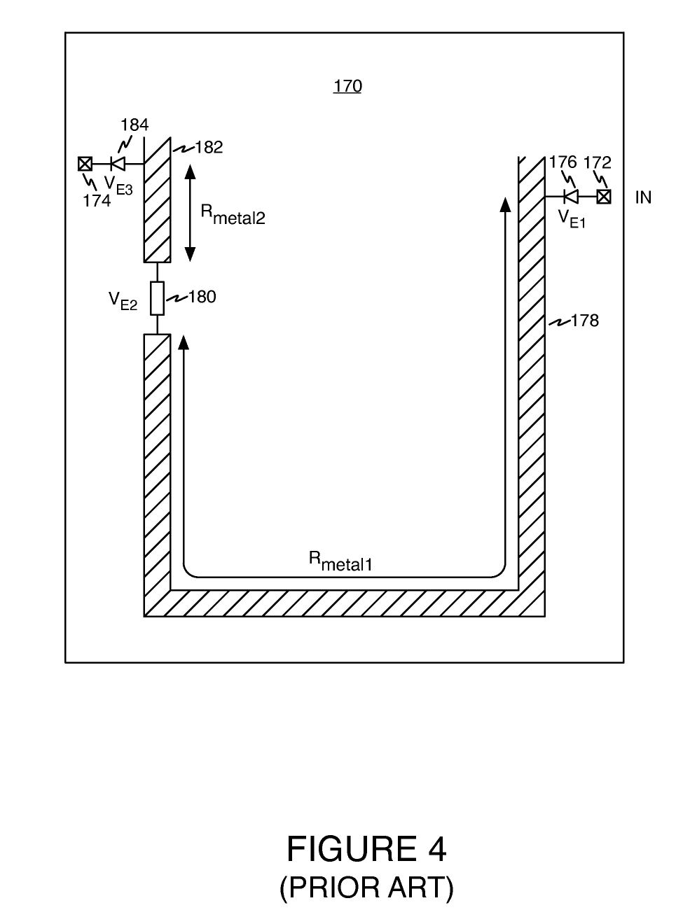

Referring now to FIG. 4, a diagram shows a prior-art example of an ESD current path which is presented here for illustrative purposes to demonstrate the prior-art approach to ESD protection for an integrated circuit. As shown in FIG. 4, an ESD current pulse may flow through a typical prior-art integrated circuit 170 from a first I/O pad 172 to a second I/O pad 174. The current pulse enters the integrated circuit 170 through I/O pad 172, passes through first ESD element 176 and to metal line 178. From metal line 178, the current flows through second ESD element 180 to second metal line 182. From second metal line 182, the ESD pulse flows through third ESD element 184 and to I/O pad 174, through which it exits the integrated circuit.

In the conventional approach to designing ESD protection for an integrated circuit, the worst-case (i.e., largest) voltage drop (V_{ESD}) for any possible ESD discharge path must be determined. The worst-case (i.e., worst-V_{EST}-case) path will typically include a number of ESD elements which, for a fixed current (I_{ESD} depending only on the ESD level being tested), have a fixed forward voltage or breakdown/clamp voltage. In the prior-art example of FIG. 4, forward or breakdown/clamp voltages of V_{E1}, V_{E2}, and V_{E3} are indicated for ESD elements 176, 180, and 184, respectively. Adding to these ESD element voltage drops the IR drops across wires Rₘₑₜₐₗ₁ and Rₘₑₜₐₗ₂ for ESD current I_{ESD}, the total voltage drop across the ESD discharge path may be expressed as:

V_{ESD}=I_{ESD}×(Rₘₑₜₐₗ₁+Rₘₑₜₐₗ₂)+V_{E1}+V_{E2}+V_{E3}

A given process technology has an experimentally-determined or modeled maximum allowed total ESD voltage (V_{ESDMAX}); no damage to the circuit is to be expected if V_{ESD}<V_{ESDMAX}. Substituting this V_{ESDMAX} value into the above equation together with the known ESD element forward or breakdown/clamp voltages (V_{E1}, V_{E2}, V_{E3}) for the given ESD discharge current (I_{ESD}), the maximum allowable wire resistance for all metal lines (Rₘₑₜₐₗ₁+Rₘₑₜₐₗ₂) in this worst-case ESD path can be determined. With the metal sheet resistance fixed by the technology and the wire length fixed by chip size, a minimum required metal width can be calculated for a particular design.

According to the present invention, the same ESD elements as found in the prior art may be used. However, unlike the prior art, the present invention purposely includes the low-resistance substrate as part of the ESD path. The prior art sum of wire resistances (Rₘₑₜₐₗ₁+Rₘₑₜₐₗ₂ in the example of FIG. 4) is effectively replaced in the present invention by the substrate resistance. With the substrate resistance typically being low due to the relatively low length-to-width ratio of practical integrated circuits (i.e., due to a relatively small number of squares for any resistive substrate path), the present invention allows a level of ESD protection comparable to the prior art without need of the relatively wide metal lines often required by the prior art.

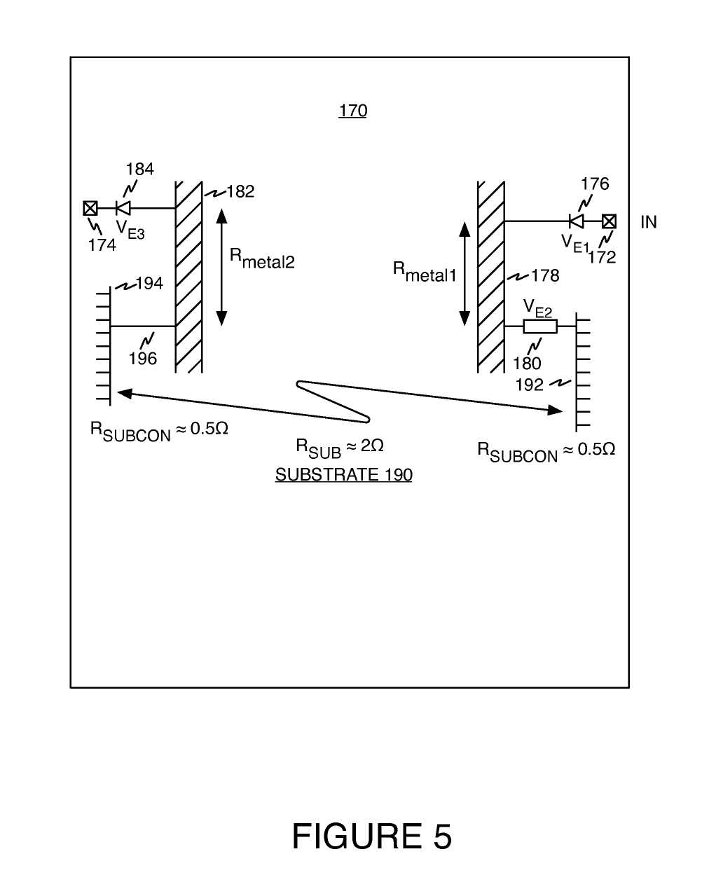

FIG. 5 is a diagram showing how an ESD current pulse may flow through a typical integrated circuit from a first I/O pad to a second I/O pad in accordance with the principles of the present invention. This worst-case ESD discharge path is the equivalent of the worst-case path shown in FIG. 4. Where circuit elements common to FIG. 4 are shown in FIG. 5, they are identified by the same reference numerals used in FIG. 4.

In the example of FIG. 5, the ESD current pulse enters integrated circuit 170 through I/O pad 172 and passes through first ESD element 176 to metal line 178. From metal line 178, the current flows through second ESD element 180 to the substrate 190 through a substrate connection shown at reference numeral 192. In cases where additional metal routing is needed between ESD element 180 and substrate connection 192, any associated additional metal line resistance can be represented and accounted for by an increase in the effective length of metal line 178, which is seen to be in series with such additional metal line(s). After substrate connection 192, the ESD current flows across the substrate 190 to a second substrate connection 194, which passes the current through to second metal line 182 via direct connection 196. From second metal line 182, the ESD current pulse flows through third ESD element 184 to I/O pad 174, through which it exits the integrated circuit.

The substrate connection (SUBCON) may be considered to include all resistance in the path from the bottom-most metal layer to the low-resistance substrate layer, and will typically include a contact resistance between the bottom-most metal layer and a top-most semiconductor bulk layer plus a vertical resistance between this top-most semiconductor bulk layer and the low-resistance substrate layer. Persons of ordinary skill in the art will appreciate that substrate connections 192 and 194 in FIG. 5 may each represent a plurality of parallel substrate connections, with any such parallel connections typically yielding a lower total resistance for the connection. In like manner, a plurality of parallel paths from first ESD element 176 to second ESD element 180 and from substrate connection 194 to ESD element 184 will typically yield a lower total resistance for each of these portions of the ESD current path.

The advantage obtained by the present invention may be seen from a sample ESD calculation. Using conventional technology as exemplified by FIG. 4, assume an allowable total Rₘₑₜₐₗ=4Ω. A typical metal sheet resistance is 0.02 Ω/square, but for a low cost technology such as used for an image sensor, it may be as high as 0.06 Ω/square. The die size is assumed to be 5,000 um/side (many large SOC chips are up to 20,000 um on a side). The worst-case path is assumed to traverse three sides of the chip, making this path 15,000 um long. The metal width required is thus calculated as 15,000 um×0.06 Ω/square±4Ω=225 um. To achieve this effective width, prior-art ESD designs will often use multiple (i.e., stacked) metal layers to carry the ESD current. This design method is described in more detail with typical requirements in the article “Influence of the series resistance of on-chip power supply busses on internal device failure after ESD stress,” Terletzki et al., IEEE Trans. On Elec. Devices, vol. 40, No. 11, November 1993, pp. 2081-2083.

In accordance with the present invention, with the same allowable Rₜₒₜₐₗ=4Ω, and with assumed values of R_{SUB}=2Ω, and R_{SUBCON}=0.5Ω (this R_{SUBCON} being the effective resistance of a connection to substrate that may include multiple connections in parallel), the calculated allowance for metal line resistance is Rₘₑₜₐₗ=4Ω−2Ω−2.0×0.5Ω=1Ω. At this point, the designer may choose from a practical range of Rₘₑₜₐₗ widths and calculate the associated allowable effective length, until a suitable combination of width and allowable length is found. Choice of a smaller width could allow a smaller die size, which could result in cost savings. However, too small a metal area could place circuit design constraints such as a more limited number of allowed ESD elements or SUBCON elements.

The designer in this present-invention example may choose metal line width W=50 um, saving up to 175 um of chip width per side or (5000²−4650²)/5000²=14% of chip area compared to the prior-art 5000 um-per-side design example. In cases where the additional 175 um of metal line width required in the prior-art example is implemented as parallel-connected stacked metal lines, it is possible the present invention may instead realize a processing cost savings by eliminating the need for some of these prior-art-required stacked metal layers. In any case, for the present-invention example with an assumed metal sheet resistance of 0.06Ω/square, the allowable length is 50 um×1Ω÷0.06Ω/square=833 um. This suggests that, with equal allowances for Rₘₑₜₐₗ on both ends of the worst case path, an effective metal length of 416 um can be allowed from each ESD element to a SUBCON element.

In some ESD paths for some power supply domains an ESD element may not be present, as, for example, in the path from substrate 144 to I/O pad 156 in FIG. 3. In such a case, the number of ESD elements is reduced by one compared to the illustrated worst-case path in the example of FIG. 5, and the allowable length of the Rₘₑₜₐₗ path to a SUBCON element may be much larger than the 416 um calculated above.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A method for conducting ESD discharge current through an integrated circuit formed on a semiconductor substrate, comprising:
providing a first path for ESD current from a first I/O pad of the integrated circuit to a portion of a first metal line in the integrated circuit;
providing a second path from the portion of the first metal line to the substrate; and
providing a third path for ESD current from the substrate to a second I/O pad of the integrated circuit.

2. The method of claim 1 wherein providing the third path for ESD current from the substrate to a second I/O pad of the integrated circuit includes providing a third path having at least portion of a second metal line.

3. The method of claim 1 wherein providing at least one of the first, second and third paths includes providing at least one of the first, second, and third paths having at least one ESD element.

4. The method of claim 2 wherein providing at least two of the first, second and third paths includes providing at least two of the first, second, and third paths each having at least one ESD element.

5. The method of claim 1 wherein providing the first and third paths includes providing the first and third paths each having at least one ESD element.

6. The method of claim 2 wherein providing the first and third paths includes providing the first and third paths each having at least one ESD element.

7. The method of claim 1 wherein providing the first path includes providing a first path from an I/O pad to a positive supply rail to an ESD element to a negative voltage rail.

8. The method of claim 7 wherein the ESD element is an active rail clamp.

9. The method of claim 7 wherein the ESD element is a voltage breakdown structure.

10. The method of claim 7 wherein the voltage breakdown structure is one of a snapback MOS device, a silicon-controlled rectifier, and an avalanche diode.

11. The method of claim 7 wherein the ESD element is a circuit that turns on in response to one of a voltage and a rate of change of a voltage exceeding a threshold.

12. The method of claim 1 wherein the first and second paths are in a first ESD domain and the third path is in a second ESD domain.

13. The method of claim 12 wherein at least one of the second and third paths is a direct connection.

14. The method of claim 12 wherein at least one of the second and third paths is a power isolation structure.

15. The method of claim 14 wherein the power isolation structure is a pair of back-to-back diodes.

16. The method of claim 12 wherein at least one of the second and third paths includes at least one ESD element.
